(19) United States
(12) Patent Application Publication
(10) Pub. No.: US 2009/0163615 A1
(43) Pub. Date: Jun. 25, 2009

(54) Uv curable hybridcuring ink jet ink composition and solder mask using the same

(76) Inventors: Izhar Halahmi, Hod-HaSharon (IL); Shalom Luski, Rehovot (IL); Michal Cohen, Rehovot (IL)

Correspondence Address: THE NATH LAW GROUP, 112 South West Street, Alexandria, VA, 22314, US

(21) Appl. No.: 11/991,062

(22) PCT Filed: Aug. 31, 2006
(86) PCT No.: PCT/IL2006/001020

§ 371 Date: Feb. 11, 2009

Related U.S. Application Data
(60) Provisional application No. 60/712,448, filed on Aug. 31, 2005.

(51) Int. Cl. C08J 3/28; C08F 2/46; B23K 3/08; B41J 2/01

(52) U.S. Cl. 522/146; 522/83; 522/82; 522/144; 522/48; 522/33; 522/39; 522/56; 522/40; 522/65; 522/46; 522/49; 522/57; 228/57; 347/102

(57) ABSTRACT

The present application provides a latent ink-jet ink formulation suitable as solder mask. The composition generally comprises: (a) at least one compound capable of self cross-linking (USM); (b) at least one phenolic resin; (c) at least one solvent; (d) at least one mineral filler; (e) at least one polyol; and (f) at least one photoinitiator.

### FIELD OF THE INVENTION

The present invention relates generally to a hybrid solder mask formulation for ink-jet applications.

### BACKGROUND OF THE INVENTION

Ink-Jet inks are special fluids that are applied by ink-jet printers as discrete droplets onto a substrate. The ink-jet technology, in comparison with other conventional printing technologies, allows the formation of an image without the need of screens and photo masks. The application of the ink is either when drop is required (drop-on-demand) or continuous. The result is thus cost effective and presents a high degree of flexibility from the user standpoint.

One of the fields of interest is electronic manufacturing, and especially the printed circuit boards (PCB) manufacturing, where solder mask, marking inks (legend or marking inks) and conformal masking inks are applied by screen printing or by coating followed by photolithography.

An important application is the solder resist (solder mask) that is applied onto the patterned conductors, pads and vias on the outer layers of PCB, in such a way that only areas that need to communicate with components (pads, connectors to be connected to semiconductor devices, passive devices and other electronic circuits) are left coating free. All other coated areas are covered by ink and protected from process liquids, soldering and environmental damages. The solder resist must meet all requirements related to chemical resistance against process media, assembly processes and long term durability as assembled board.

Unlike graphic art inks that are subjected to mild environments, the solder mask is exposed to harsh environment during PCB manufacturing such as soldering (hot air level soldering, wave and Reflow in presence of flux, all referred hereinafter as HASL), surface finishes of copper pads and surfaces, such as immersion tin, electroless nickel and gold plating (referred hereinafter as ENIG) and organic soldering preservatives (referred hereinafter as OSP). The solder mask also needs to sustain long term environmental stresses for long periods of time under changing temperatures and humidity.

The requirements of a solder mask are listed in IPC SM-840C—the international specifications standards established by the Institute of Interconnecting and Packaging Electronic Circuits. These requirements need not only to be in concert with the conditions employed during the PCB manufacture but also with the method of application of the solder mask formulation onto the PCB surface.

Ink-jet formulations and especially industrial printers require ink that is very latent (namely, the viscosity at the application temperature and at shear rate in the range of 1000-100,000 sec⁻¹ should not increase by more than 2-10 Cps during storage and operation, over a period of usually at least 2 months, more typically 3-6 months). Most of the high performance thermoset resins, found in most commercially available solder masks, such as epoxy, are not latent enough. If a conventional epoxy solder mask (such as Novolac epoxy which is cured by dicyandiamide (DICY) or Novolac epoxy cured by imidazole or anhydride or aromatic amine) is loaded into an ink jet printer, the viscosity will increase within a period of few hours to few days to a level at which the nozzles will clog and the ink jet system will be irreversibly damaged. On the other hand, thermosetting resins that are latent enough (amino resins, for example) to overcome the long term residency in the printer are not typically chemically resistant enough. Even when high cross linking density is achieved, e.g., by the introduction of a polyol, hydrolytic stability is not sufficient to survive the soldering and surface finishing media that are applied in the printed circuit board (PCB) industry.

UV curable inks based on unsaturated monomers and oligomers such as acrylates and methacrylates are more chemically stable than amino resin based inks, but have poorer adhesion to the substrate due to a high degree of shrinkage during curing.

European Patent No. EP 1543704 provides a process for making an electronic device which comprises applying a non-aqueous solder mask ink which is substantially free from organic solvents to a dielectric substrate containing electrically conductive metal circuitry wherein the solder mask ink comprises acrylate functional monomers, metal adhesion promoting organic compound, initiators, polymers and/or prepolymers, colorants and surfactants.

US Patent Application No. 2006/0019077 which discloses a process for making a printed circuit board having a solder mask and area(s) of exposed metal circuitry based on photo-initiated cationic curing of epoxy resins or oxirane groups compounds comments on the poor performance of free radical curing and acrylate based solder mask of the sorts disclosed in EP1543704.

This US patent application specifically notes that the reducing agents and/or the pH/thermal conditions used in electroless plating tend to aggressively attack known ink jet inks which are free-radical curing and acrylate based. Whilst the mechanism of such attack is not understood the visible observation (when a free radical cured acrylate based solder mask is exposed to typical electroless plating conditions) is that the solder mask disintegrates and/or delaminates. It is speculated in the US application that the poor performance of free radical curing and acrylate based ink to electroless plating may be a result of aqueous hydrolysis and/or of chemical attack by the reducing agents used.

The cationic curing based epoxy mask, is not free from drawbacks as well: the major drawbacks of such technology is curing inhibition by humidity or basic contaminations, and risk of “dark curing” in the print-head and the ink system (slow reaction of cross-linking provided by the natural dissociation of curing agent, wherein the acidic byproduct is active for days and even weeks, even in dark environment).

Since ENIG and similar surface finishes are becoming more and more popular in the PCB industry, it is highly important to provide a solder mask which on one hand has improved resistance against those finishes and on the other has the appropriate chemical and physical characteristics so it may be applied by ink jet.

### SUMMARY OF THE INVENTION

The inventors of the invention disclosed herein have successfully developed an ink formulation (herein referred to interchangeably as “the ink formulation”, “the ink”, or “the formulation of the invention”) which is adapted to overcome the drawbacks of existing solder mask formulations such as the one disclosed in European patent no. EP 1543704, especially with regards to shrinkage during curing and poor adhesion as a result of said shrinkage and insufficient cross-linking density, and in US application no. 2006/0019077, with respect to curing inhibition by humidity or basic contaminations, and risk of “dark curing” in print-head and ink system.

The ink provided by the present invention is designed to be applied onto printed circuit boards (PCBs) by ink-jet, partially cross-linked by exposure to light to a tack-free state, and fully cross-linked by thermal curing, so as to afford a hard and a highly chemical and thermal resistant solder mask.

Thus, in a first aspect of the present invention, there is provided an ink-jet ink formulation comprising: (a) at least one compound capable of self cross-linking (hereinafter referred to as USM); (b) at least one phenolic resin; (c) at least one solvent; (d) at least one mineral filler; (e) at least one polyol; and (f) at least one photoinitiator.

In one embodiment, the ink formulation is latent.

In another embodiment, said ink formulation is suitable for use as solder mask. Herein, “solder resist” is used interchangeably with the term “solder mask”. Both terms refer to a permanent insulative layer that is applied onto outer layers of PCB or other functional interconnecting device, in a manner covering and protecting lines, vias and spaces, and leave open only functional portions to be interconnected with semiconductor devices, capacitors, diodes and resistors, as well with other electronic devices, wires or boards.

As used herein, the term “latent ink” or any lingual variation thereof refers to a viscosity change of the said ink formulation of at most 10 Cps (centipoises), measured at a jetting temperature below 100° C., at a shear rate of at least 1,000 sec⁻¹, after the formulation having been stored for at least 3 months at ambient (namely, at a temperature of about 22-25° C.). The unit “Cps” (Centipoise) as used herein refers to the viscosity-measuring unit, defined as a centimeter-gram-second unit of dynamic viscosity equal to one hundredth (10⁻²) of poise.

The formulation of the present invention exhibited the following pre-curing characteristics:

(1) a viscosity lower than 50 Cps at a shear rate of 10 to 100,000 sec⁻¹ as measured at a temperature lower than 100° C. (degrees Celsius), and a surface tension lower than 40 dynes/cm measured at the same temperature; and

(2) a suitable latency—the formulation's viscosity remained unchanged for prolonged periods of time when stored at temperatures of ambient or lower.

The term “viscosity” refers to the ratio between shear stress and shear rate. The viscosity of polymeric inks is usually non-Newtonian, namely the viscosity changes as shear rate changes. In most inks, the viscosity decreases as shear rate increases (the so-called Shear-Thinning effect).

The term “shear rate” refers to the ratio between velocity of a liquid and the distance between the two shearing planes (for example tube wall, nozzle diameter):

$$\frac{Velocity}{Clearance} = \frac{cm \text{/} sec}{cm} = {sec}^{- 1}$$

The term “surface tension” refers to a property of liquids arising from unbalanced molecular cohesive forces at or near the surface, as a result of which the surface tends to contract and has properties resembling those of a stretched elastic membrane. Surface tension, measured in Newtons per meter (N·m⁻¹), or Dynes per cm, is represented by the symbol σ or γ or T and is defined as the force along a line of unit length perpendicular to the surface, or work done per unit area.

The cured ink exhibited the following characteristics:

(1) a tack-free and no flow state after being printed on a substrate e.g., PCBs or printed wired boards (PWB) or any other solid layer being in use in electronic manufacturing, and partially cross-linked by exposure to ultraviolet radiation or visible light;

(2) durability of the film after having been partially cross-linked by exposure to ultraviolet radiation or visible light, followed by fully cross-linked thermally at a temperatures between 120° to 200° C.;

(3) high resistance to chemical and thermal stresses related to the harsh environment of PCB manufacturing and service conditions after manufacturing; and

(4) electrical reliability which stemmed from high cross-linking density and low residency of chlorides and mobile ions in the cured film.

The term “tack-free” as used herein refers to a state of cross-linking and/or drying, wherein the outer surface of the film is dry and has no tack to the surface of the ink jet printer table or adjacent PCB board or substrate. The term “no-flow” refers to a state of cross-linking and/or drying, wherein the liquid ink is a thick fluid or solid, exhibiting no flow on the substrate.

In one embodiment of the present invention, said formulation is characterized by having a viscosity lower than 50 Cps at a shear rate of 10 to 100,000 sec⁻¹ measured at a temperature lower than 100° C., and a surface tension lower than 40 dynes/cm at the same temperature.

Within the context of the present invention, said “at least one compound capable of self cross-linking” (herein referred to as unsaturated monomer or USM) is an unsaturated monomer or oligomer capable of self cross-linking via free-radical mechanism. Preferably, said USM has a glass transition temperature (Tg) of at least 80° C.

In one embodiment, said self cross-linking is achieved via at least one unsaturated group selected, in a non limiting manner, from acryl, methacryl, vinyl, fumaryl, allyl ether, allyl ester and any combination thereof, said unsaturated group being covalently bonded to a backbone selected in a non limiting manner, from polyhydric alcohol, isocyanuric acid and derivatives thereof, novolac resin, urethane containing oligomers, amide containing oligomers, epoxy resin and derivatives thereof, isobornyl and derivatives thereof, imide containing oligomer, cycloaliphatic ring system having at least one cycloaliphatic ring, heterocyclic ring system such as triazine and derivatives thereof.

In another embodiment the USM is characterized by a molecular weight lower than 5,000 Daltons and more preferably lower than 2,000 Daltons.

In yet another embodiment the USM is characterized by a viscosity lower than 500 Cps at a temperature lower than 100° C.

As used herein, any of the organic groups, radicals and substituents are to be given the broadest definition as known to a person skilled in the art.

In one embodiment, said USM is selected from isobornyl acrylate or methacrylate; acrylate or methacrylate esters of short polyols and polyhydric alcohols; urethane acrylate or methacrylate; acrylate or methacrylate esters of short diols; acrylate or methacrylate ester of alkoxylated polyols; acrylate or methacrylate ester of tris-2-hydroxyethyl isocyanurate (THEIC); acrylate or methacrylate esters of cycloaliphatic diols and polyols; high functionality polyacrylate or methacrylate; allyl ethers; allyl esters; triazine based acrylates or methacrylates; dendritic polyol acrylates or methacrylates; imide group containing acrylates or methacrylates; and the reaction product of acrylic acid or methacrylic acid with novolak epoxy resins or bisphenol based epoxy resins.

The phenolic resin employed in the formulation of the invention is a phenol-based resin.

In one embodiment, said phenolic resin is selected, in a non limiting manner, from (a) phenol aldehyde condensates (known as novolak resins) including hydrogenated grades thereof, (b) homopolymers and copolymers of alkenyl phenols including hydrogenated grades thereof, (c) poly(vinyl phenol) resin, including co-polymers of (vinyl phenol) with other unsaturated monomers such as styrene, acrylic or methacrylic acid and esters thereof, and including hydrogenated grades of said homopolymers and copolymers (d) oligomers and polymers comprising phenolic units and non-aromatic cyclic alcohol units including hydrogenated grades thereof, and (e) homopolymers and co-polymers of N-hydroxyphenyl-maleimides.

In another embodiment, said phenolic resin is poly (vinyl phenol) resin, including co-polymers and hydrogenated grades thereof.

In a further embodiment, said phenolic resin is etherified.

Some commercially available phenolic resin are provided as solid materials and usually need to be pre-dissolved in an appropriate solvent as will be disclosed hereinnext. Other commercially available phenolic resins, are provided as pre-dissolved solutions, usually about 15 to 50% of said solution is a solvent. Preferably, said solvent is an organic solvent selected in a non-limiting manner from ethers, alcohols, glycols, lactones, esters, cyclic amides, cyclic esters, ether-esters, alkyl carbonates, ketones, aromatic, aliphatic, amide, cycloaliphatic, silyl solvents (solvents comprising Si—O linkage in main chain), and combinations thereof. More preferably, said solvent is a volatile hydroxylated solvent, as defined herein. Most preferably, said hydroxylated solvent is ethanol, propanol, butanol or iso-butanol.

As used herein, the term “hydroxylated solvent” refers to an organic solvent having at least one OH group substituted thereto. The term includes mono-hydroxylated (monohydric) solvents such as methanol, ethanol, propanol, iso-propanol, butanol, hydroxy acetone, amyl alcohol, and iso-butanol; di-hydroxylated (dihydric) solvents such as ethylene glycol, diethylene glycol and triethylene glycol, propylene glycol, di propylene glycol, tripropylene glycol, and 1,4-butandiol, and polyhydroxylated (polyhydric) solvents.

The term “volatile” refers to a solvent having a boiling point lower than 280° C. and more preferably lower than 230° C. at 1 atmosphere.

The solvent used for the dissolution of e.g., the phenolic resin may or may not be the same as the solvent employed in the formulation of the invention according to the first aspect of the invention. Within the context of the present invention, the “solvent” employed by the formulation is an inert liquid (namely, a solvent which is non-reactive with the USM and/or phenolic resin during storage, and evaporates from the printed ink during the drying and curing stage) which has a viscosity in the range of 1 to 15 Cps at ambient.

In one embodiment, said at least one solvent is selected, in a non limiting manner, from ethers, alcohols, glycols, lactones, cyclic esters and cyclic amides esters, ether-esters, alkyl carbonates, ketones, aromatic, aliphatic, amide, cycloaliphatic, silylic solvents, and combinations thereof. Preferably, said at least one solvent is a volatile hydroxylated solvent, as defined hereinbefore. Most preferably, said at least one solvent is ethanol, propanol, butanol or iso-butanol.

As used herein, said “mineral filler” is a particulate material, each particulate having a substantially spherical or oval shape with an aspect ratio of between 1 to 5. The average particle size of each of said particulates is preferably less then 5 microns, more preferably less than 2 microns, wherein said average size refers to the averaged longest radius. The mineral filler being a plurality of said particulates is thus substantially free of irregularly shaped and/or porous filler particulates.

In one embodiment, the mineral filler is selected in a non limiting manner from metal oxides, metal carbonates, metal sulfates, metal phosphates, alumosilicates, kaolin, talc, wollastonite, mica, silica and silicates. In one preferred embodiment, said metal carbonate is calcium carbonate, said metal sulfate is barium sulfate and said silicate is quartz.

In a specific embodiment, said filler has a surface area lower than 100 m²/gr.

In another embodiment, said mineral filler has a refractive index in the range of about 1.4 to 1.7, to provide the pre-cured print the desired transparency which allows UV radiation or visible light to penetrate it completely, even at a thickness of, for example, between about 10 to 60 microns, so photo-induced cross-linking is enabled along the cross section of the mask print layer.

The component of the formulation referred to as the “polyol” is a non volatile compound which comprises at least one hydroxyl (—OH) group, which is reactive towards said phenolic resin and other cross-linkers.

In one embodiment, the polyol is selected from compounds having at least one hydroxyl group reactive towards said phenolic resin at temperatures of about 120 to 220° C., but latent at ambient. In a preferred embodiment, the polyol further comprises an unsaturated group, so as the reactivity with said USM is enabled.

In another embodiment, said polyol is selected from acrylate and methacrylate esters of polyhydric alcohols. In another embodiment, said polyol is selected from allyl esters such as allyl pentaerythritol and allyl ethers such as allyl ethers of trimethylol propane or pentaerythritol or glycerol. In yet another embodiment, said polyol is a cycloaliphatic polyol such as cyclohexane dimethanol.

The at least one photoinitiator, as known to a person skilled in the art, is a compound that is capable of initiating polymerization or a cross-linking reaction upon exposure to actinic radiation. Preferably, said actinic radiation is UV radiation and/or visible light. More preferably, said actinic radiation is in the wavelength range of 300-450 nm.

In one embodiment, said photoinitiator is selected from free radical generating photoinitiators, cationic photoinitiators, and anionic photoinitiators or combinations thereof. Preferably, said photoinitiator is a free-radical generator selected from anthraquinone and derivatives thereof; acetophenones; 1-hydroxy cyclohexyl-phenylketone and 2-methyl-1-(4 methylthio) phenyl-2-morpholin-propan-1-one; thioxanthones; ketals; benzoins and benzoin alkyl ethers; azo compounds; benzophenones; and mixtures thereof.

In another embodiment, said photoinitiator is a cationic radical generator selected from triarylsulfonium (TAS) and diaryliodonium (DAI) salts, oxime sulfonate, and diazonium salts.

The ink formulation may further comprise at least one amino resin cross-linker, capable of reacting with hydroxyl groups and with said phenolic resin and provides improved adhesion and impact resistance. The amino resin is selected, in a non limiting manner, from melamine monomer or polymer, melamine-formaldehyde resins, benzoguanamine-formaldehyde resins, urea-formaldehyde resins, glycoluril-formaldehyde resins, triazine based amino resin and any combination thereof.

In another embodiment, the ink formulation further comprises at least one sensitizer to improve the ink's sensitivity to light, the efficiency of the reaction between the free radicals and said USM and the unsaturated polyol, thus allowing higher efficiency of the photo-curing process at lower content of photoinitiator. The sensitizer is also used to improve the control of print quality.

The photo-curing e.g., by UV radiation and/or visible light, provides a partially cured ink to a level enabling tack-free or no flow state but without the loss of adhesion related to high degree of USM cross-linking. A case where the photo-curing process provides nearly full cross-linking level, namely the ink undergoes full cross-linking, and the resulting film has insufficient adhesion as disclosed for example in EP1543704, is avoided in the case of the formulations of the present invention.

In another embodiment, the formulation of the invention further comprises at least one pigment, dye, wetting agent (being preferably selected from fluoro-surfactants; silicone-surfactants, polyether modified poly dimethyl siloxane and polyacrylate-surfactants), dispersing agent (being preferably selected from low molecular weight dispersants and high molecular weight dispersants), blocked strong acid catalyst, adhesion promoter, defoamer, curing inhibitor (being preferably a volatile amine inhibitor such as N-methyldiethanolamine, MDEA), or any combination thereof.

The pigment and/or dye employed in the formulation of the present invention is selected amongst pigments or dyes which color remains substantially unchanged under conditions employed in the processes of PCB manufacturing. Preferably, said pigment or dye is green or blue. More preferably, said pigment is phtalocyanine green or blue.

In a preferred embodiment, the formulation comprises:

(a) at least one USM in an amount between about 5 to 70%, more preferably between about 5 to 60% and most preferably between about 5 to 50% of the total weight of the formulation;

(b) at least one phenolic resin in an amount between about 1 to 50%, more preferably between about 1 to 30% and most preferably between about 1 to 20% of the total weight of the formulation;

(c) at least one solvent in an amount between 2 to 25%, more preferably between about 2 to 15% and most preferably between about 2 to 12% of the total weight of the formulation;

(d) at least one mineral filler in an amount ranging from about 1 to 70%, more preferably about 1 to 50% and most preferably about 1 to 40% of the total weight of the formulation;

(e) at least one polyol in an amount between 1 to 50%, more preferably between 1 to 30% and most preferably between 1 to 20% of the total weight of the formulation;

(f) at least one photoinitiator in an amount between 1 to 20%, more preferably about 1 to 15% and most preferably 1 to 10% of the total weight of the formulation.

In another preferred embodiment, the ink formulation comprises between about 5 to 50% USM, 1 to 40% phenolic resin, 2 to 20% solvent, 0 to 20% amino resin, 5 to 60% mineral filler, 2 to 40% polyol, 1 to 15% photoinitiator, 0 to 5% pigment or dye and 0 to 10% wetting and/or dispersing agents, of the total weight of the formulation.

In yet another preferred embodiment, said polyol is substituted by at least one unsaturated group.

In still another preferred embodiment, the ink formulation comprises between about 5 to 50% USM, 1 to 40% phenolic resin, 2 to 20% solvent, 0 to 20% amino resin, 0 to 30% epoxy resin or monomer, 5 to 60% mineral filler, 2 to 40% polyol substituted by at least one unsaturated group, 1 to 15% free-radical photoinitiator, 1 to 10% cationic photoinitiator, 0 to 5% pigment or dye and 0 to 10% wetting and/or dispersing agents, of the total weight of the formulation.

In another preferred embodiment, the ink formulation further comprises between 1 to 10% blocked strong acid catalyst of the total weight of the formulation.

In a still further preferred embodiment, the ink formulation comprises:
(a) 6.99% polyol such as SR 444 manufactured by Sartomer;
(b) 13.50% USM such as SR 238 manufactured by Sartomer;
(c) 33.22% USM such as SR 506D manufactured by Sartomer;
(d) 10.07% phenolic resin solution such as FB 210 B 60 (60% phenolic resin, 40% butanol) manufactured by Schenectady;
(e) 7.69% amino resin such as Cymel 325 (70-75% amino resin, 25-30% butanol) manufactured by CYTEC;
(f) 1.98% AC-POL such as Sarbox500E50 manufactured by Sartomer;
(g) 17.94% mineral filler such as barium sulfate Blank Fixe micro manufactured by Sachtleben;
(h) 0.39% mineral filler such as Aerosil R972 manufactured by Degussa;
(i) 0.45% dispersing agent such as DisperByk 111 manufactured by BYK-CHEMIE;
(j) 2.87% dispersing agent such as DisperByk 168 manufactured by BYK-CHEMIE;
(k) 0.12% dispersing agent such as DisperByk 163 manufactured by BYK-CHEMIE;
(l) 0.40% pigment such as Hostaperm Green GGO 1 manufactured by Clariant
(m) 0.12% wetting agent such as Byk 358 manufactured by BYK-CHEMIE;
(n) 3.53% free radical generating photoinitiator such as Irgacure 907 manufactured by CIBA; and
(o) 0.73% curing inhibitor such as MDEA.

The percent expressions used herein refer to percent weight of a specific component of the total weight of the ink formulation. For example, the expression “1-50%” of a certain component refers to any ratio from 1% of the total weight of the formulation up to 50% of the weight of the same formulation. The expression “between about 1-50%” refers to a percent weight which may be slightly below or slightly above the whole percentage value. For example, “about 1%” refers also to 0.6, 0.7, 0.8, 0.9, 1.1, 1.2, 1.3 etc percent. It should be recognized that such variations on the whole numerical values are equivalents and thus fall within the scope of the claimed invention.

In another aspect of the present invention, there is provided a method for manufacturing an ink-jet ink formulation of the present invention, said method comprises:

(i) providing a solution of a phenolic resin in at least one first solvent, wherein said solution has a solid content of about 20 to 80% w/w; said solution may be commercially available or prepared on site;

(ii) admixing at least one polyol, at least one USM, optionally at least one second solvent, at least one photoinitiator and at least one filler into said solution of step (i);

(iii) dispersing the mixture of step (ii) by means of high shear;

(iv) milling the dispersed mixture of step (iii) until at least 90% of the mixture weight is able to pass through a 2- or less micron filter; and

(v) adjusting the viscosity and surface tension of the filtered formulation of (iv) by adding a further amount of said first or said second solvent or at least one of a different solvent, thereby obtaining the desirable ink formulation.

In one embodiment, said first solvent, said second and said different solvent are identical. In another embodiment, said first solvent is different from said second solvent.

In another embodiment of the above method, at least one wetting agent, and/or dispersing agents, and/or adhesion promoter, and/or curing inhibitor is added in step (i). In yet another embodiment, at least one USM, at least one photoinitiator, and optionally at least one sensitizer, or any combination thereof is added in step (v).

In another aspect of the present invention, there is provided a solder mask formulation for PCB being adapted for ink-jet printing, characterized by having a viscosity lower than 50 Cps at a shear rate of 10 to 100,000 sec⁻¹ measured at a temperature lower than 100° C. and a surface tension lower than 40 dynes/cm at the same temperature.

In another aspect of the present invention, there is provided a method for ink-jetting a solder mask ink formulation according to the present invention onto a substrate, said method comprising:

(i) providing said ink formulation according to the method of the invention or any method which provides any of the formulations disclosed herein;

(ii) applying said ink formulation onto a first face of a substrate;

(iii) irradiating said substrate of (ii) by UV radiation and/or visible light, to afford a partially cured, tack-free solid print, said print being preferably a mark (such as lines, dots figures, etc), a character or a film;

(iv) optionally repeating steps (ii) to (iii) on a second face of said substrate;

(v) optionally irradiating said first face and/or said second face of said substrate by a high power UV source and/or visible light source having an intensity of at least 200 mW/cm² in the range 300-450 nm; and

(vi) curing said first face and/or said second face of said printed substrate at a temperature of about 120 to 220° C.

In one embodiment, said substrate is a metal surface or metal oxide surface, glass, plastic composite, ceramic and combinations thereof or a PCB. Preferably, said substrate is PCB, preferably the outer layer thereof, wherein said PCB outer layer is the outermost layer of a multilayered PCB, bilayer PCB or a single sided PCB, comprising a plurality of conductive metallic lines and pads, vias, bare laminate and through holes—free or plugged.

In another embodiment, said print is a solder mask.

In another aspect of the present invention, there is provided a solder mask prepared by the method of the present invention, or by employing any one formulation of the present invention. In one embodiment, said cured solder mask is characterized by a dielectric strength of between 200 to 5,000 V/mil. In another embodiment, said solder mask is characterized by a resistance to electromigration measured at least 5×10¹² Ohms.

In yet another embodiment, said solder mask prepared from the formulations of the present invention, or by the printing method of the invention has the characteristics required by the IPC-SM-840-C standard, (Class H and Class T), a protocol written and revised by the Institute for Interconnecting and Packaging Electronic Circuits, as demonstrated hereinbelow.

### DETAILED DESCRIPTION OF THE INVENTION

While the present invention specifically discloses a formulations and methods suitable for applications by ink-jet printers, it should be understood by a person skilled in the art that the formulations and methods disclosed herein may also be utilized by employing other printing methods and for other applications. It should also be recognized, that while the formulations of the invention are used primarily for solder masks, other uses may be envisioned.

Additionally, it should be understood that the specific reagents disclosed herein are provided as mere examples and may be replaced by others suitable for the specific applications.

The ink formulation of the present invention has been shown to comprise of the unique and novel combination, which allowed overcoming the deficiencies of currently available solder mask formulations for application by ink jet, as discussed hereinbefore.

The formulation comprises (a) at least one USM; (b) at least one phenolic resin; (c) at least one solvent; (d) at least one mineral filler; (e) at least one polyol; and (f) at least one photoinitiator.

The USM is an unsaturated monomer or oligomer capable of being self-cross-linked via free radical mechanism in response to exposure to UV radiation or visible light and as such capable of photo curing. Since high heat stability is necessary for solder mask formulations, the glass transition temperature (Tg) of said USM (when self cross-linked) should be at least about 80° C. The USM typically comprises one or more unsaturated groups per molecule, said unsaturated groups being selected, in a non limiting manner from compounds comprising at least one C—C double or triple bond, capable of self polymerizing under free radical conditions, acryl, methacryl, vinyl, fumaryl and allyl, wherein said group is covalently attached to a the backbone of the USM. This backbone may for example be polyhydric alcohol, isocyanuric acid or derivatives thereof, novolac resin, epoxy resin or derivatives thereof, isobornyl or derivatives thereof, imide-group containing oligomer, cycloaliphatic, or triazine or derivatives thereof. The covalent linking may be via ether, ester, amide, urethane, imide, methylene, ethylene, alkylene, arylene, silicone, carbonate, sulfur or sulfone groups.

Non-limiting examples of USMs according to the present invention are: isobornyl acrylate or methacrylate, such as SR 506 and SR423 by Sartomer; acrylate esters of short polyols and polyhydric alcohols such as SR 238, SR 295, SR 454, SR 494, SR 355, SR 306, SR 399, SR9041, by Sartomer; urethane acrylate, such as CN9006, CN9008, CN977, CN983, CN999, CN985, CN997, CN975, CN968 by Sartomer, BR 941 by Bomar Specialties and IRR575 by UCB Surface Specialties; acrylate or methacrylate esters of short diols such as SR230, SR212, SR508, SR247 by Sartomer; alkoxylated polyols such as SR9008, CD540 by Sartomer; Kayarad D-330, Kayarad DPCA-60, Kayarad DPCA-20, Kayarad TPA-330, Kayarad TPA-320 and Kayarad PET-30 by Kayaku; acrylate ester of tris-2-hydroxyethyl Isocyanurate (THEIC) such as SR 368 by Sartomer; acrylate esters of cycloaliphatic diols and polyols, such as SR833S (also referred to as tricyclodecane dimethanol diacrylate), PRO6622, NTX7393, PRO7149 by Sartomer; Kayarad R-604 and Kayarad R-684 by Kayaku, high functionality polyacrylate, such as CN2303 by Sartomer; allyl ether, allyl esters, especially diallyl phthalate and triallyl isocyanurate, such as SR 533 by Sartomer, and triallyl cyanurate, such as SR 507 by Sartomer; BMA-200 and BMM-215 triazine based melamine methacrylates by Bomar Specialties; dendritic polyol acrylates or methacrylates, such as BDE 109 by Bomar Specialties; Imide group containing acrylates or methacrylates such as BRI-141 by Bomar Specialties; and the reaction product of acrylic acid or methacrylic acid with novolak epoxy resins or bisphenol based epoxy resins, such as Kayarad EAM-216, Kayarad EAM-21300, Kayarad R-130, Kayarad R-205 by Kayaku.

The USM content in the formula assists in achieving a balance between the tack-freeness as a response to UV and/or visible light exposure and the shrinkage during curing. If small amounts of USM are used, for example <2%, the printed ink remains tack after exposure to light and thus printing of second side is not enabled. If however, the amounts of USM in the formulation exceed, e.g. 70%, shrinkage during curing occurs which deteriorates the adhesion to the surface, resulting in an insufficient resistance to chemical surface finishes such as ENIG and thermal shocks associated to soldering.

Another negative aspect of high USM content, i.e., more than 70% of the total weight of the formulation, is the high concentrations of mobile ions such as chlorides in the cured film. Limiting the concentration of mobile ions in the film, provides high electrical reliability as solder mask is provided, especially under heat and humidity. The excellent electrical properties exhibited by the cured films prepared from the formulations of the invention, are achieved by the use of the appropriate amounts of USM and the use of high purity phenolic resins, polyol, solvents and mineral fillers.

Thus, in one embodiment, the ink formulation of the present invention comprises between about 5 to 70% USM, more preferably between about 5 to 60% and most preferably between about 5 to 50%, of the total weight of the formulation.

The term “resin” refers to a monomer, oligomer, polymer or any combination of said compounds characterized by an average of more than one reactive group per molecule, said reactive group being able to react with a second reactive compound (so called “cross linker”) to form a cross-linked thermosetting network.

The expression “capable of self cross linking” or any lingual variation thereof, refers to the ability of a molecule to form a cross-linked thermosetting network with another identical molecule under the curing conditions of the procedure.

As stated hereinbefore, the phenolic resins are phenol-based resins which impart to the cured ink, high chemical and thermal resistance and good electrical resistivity, even under hot and humid conditions. Phenolic resins are very latent when provided into the formula, especially in the presence of a volatile hydroxylated solvent.

Non-limiting examples of phenolic resins are (a) phenol aldehyde condensates (known as novolak resins) including hydrogenated grades thereof, (b) homopolymers and copolymers of alkenyl phenols including hydrogenated grades thereof, (c) poly(vinyl phenol) resin, including co-polymers of (vinyl phenol) with other unsaturated monomers such as styrene, acrylic or methacrylic acid and esters thereof, and including hydrogenated grades of said homo-polymers and copolymers (d) oligomers and polymers comprising phenolic units and non-aromatic cyclic alcohol units including hydrogenated grades thereof, (e) and homo-polymers and co-polymers of N-hydroxyphenyl-maleimides.

Preferably, said phenolic resin is poly (vinyl phenol) resin, including co polymers and hydrogenated grades thereof.

The phenolic resin may be etherified for improved latency and flexibility. Preferably, the phenolic resin employed by the formulation of the present invention is selected from vinyl phenol resins such as Maruka Lyncur resins manufactured by Maruzen Japan. These resins have the following chemical structure:

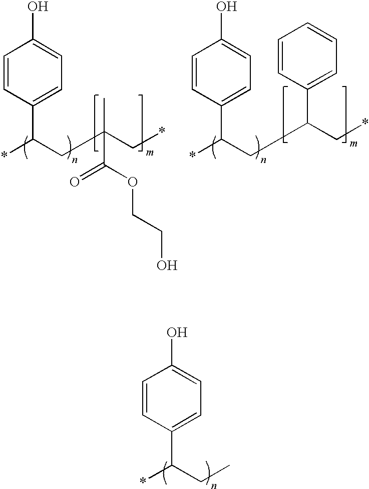

Other preferred phenolic resins are etherified phenolic resins of the following general structure:

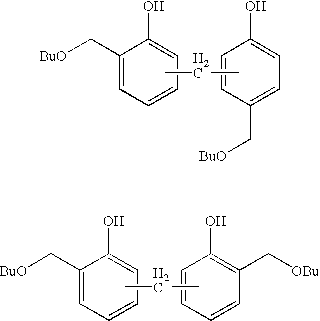

These resins may be provided as ready-to-use solutions in butanol. An example of such a resin is the FB210 B60 resin manufactured by Schenectady.

In order to achieve full dissolution of the organic-soluble phenolic resin in the ink formulation, it is preferable to first dissolve the phenolic resin in a suitable organic solvent which will prevent the resin from precipitating out during the preparation of the formulation or during storage. For example, a solution of solid phenolic resin, such as the Maruka Lyncur resin, was prepared by mixing the resin in a solvent selected from ethers, alcohols, glycols, lactones, cyclic esters and cyclic amides esters, ether-esters, alkyl carbonates, ketones, aromatic, aliphatic, amide, aliphatic, cycloaliphatic, silyl solvents, and combinations thereof. Preferably, a volatile hydroxylated solvent such as methanol, ethanol, propanol, iso-propanol, butanol, hydroxy acetone, amyl alcohol, and iso-butanol; di-hydroxylated (dihydric) solvents such as ethylene glycol, diethylene glycol and triethylene glycol, propylene glycol, di propylene glycol, tri propylene glycol, and 1,4-butandiol, and polyhydroxylated (polyhydric) solvents is recommended due to its capability to suppress self polymerization of the said phenolic resin during storage.

In one preferred embodiment, the phenolic resin solution comprises about 40 to 80% phenolic resin and about 20 to 60% solvent w/w.

In order to achieve the improved chemical and thermal resistance, it was found that the formulation should comprise between about 1 to 50%, more preferably between about 1 to 30% and most preferably between about 1 to 20% phenolic resin of the total weight of the formulation.

The solvent is required for several reasons; the first being the need to increase the solubility of the formulation components. For example, phenolic resins are poorly miscible in the USM, especially at the high Tg grades where the viscosity is also relatively high, thus requiring the presence of a volatile inert medium (having no reactivity towards any of the components of the formulation under the conditions employed), to increase the solubility of the resin in the USM and reduce the viscosity thereof. If low molecular weight USM is used as a diluent (so called reactive diluent) instead of the inert solvent, shrinkage during curing may be too high and solubility of the phenolic resin in said formulation may be insufficient, resulting in the precipitation of the phenolic resin during storage.

Choosing the appropriate solvent may also be beneficial in adjusting the formulation's surface tension to between 28 and 34 dynes/cm, a range, which is necessary for stable ink-jetting, and also beneficial in arresting any self cross-linking of the phenolic resin during storage.

The solvent which meets the above criteria and thus is suitable for use in the formulation of the invention is a solvent selected from organic ethers, alcohols, glycols, lactones, cyclic esters and cyclic amides esters, ether-esters, alkyl carbonates, ketones, aromatic, aliphatic, amide, aliphatic, cycloaliphatic, silyl solvents, and combinations thereof.

The solvent may be a single solvent or a mixture of solvents, each preferably being selected from volatile alcoholic or glycolic solvents. In a preferred embodiment the solvent is butanol or iso-butanol.

The solvent or a mixture of solvents may be present in the formulation as a diluent of one or more of the components of the formulation, e.g., the phenolic resin or as an additive which is added to the formulation in order to adjust its physical and chemical properties.

In another preferred embodiment, the solvent constitutes between 2 and 10% of the total weight of the formulation.

The mineral filler acts in the formulation as a stress damper. Since the filler is non-reactive, it reduces the over-all shrinkage of the solder mask during photo-curing. Lowered shrinkage, which is crucial for reduced residual stress in the cured solder mask and for the film adhesion and durability was achieved by a high load of filler.

The mineral filler is a particulate material, each particulate preferably having spherical shape, substantially free of irregularly shaped and porous particulates. In one embodiment, said filler comprises particulates having an average particulate size of less then 5 microns, more preferably less than 2 microns. In another embodiment, said filler has a surface area less than 100 m²/gr.

Non-limiting examples of such mineral fillers are metal oxides, metal carbonates, metal sulfates, metal phosphates, alumosilicates, kaolin, talc, wollastonite, mica, silica and silicates. Preferably, the mineral filler is barium sulfate and quartz.

In one embodiment, the mineral filler is one which does not affect the transparency of the ink formulation to light in the wavelength range of 300-450 nm.

In a preferred embodiment, said filler has a refractive index of about 1.4 to 1.7. In another preferred embodiment, the filler is barium sulfate, more preferably precipitated barium sulfate, such as Blank Fixe manufactured by Sachtleben (Germany) and Cimbar BF manufactured by Cimbar (USA).

In another preferred embodiment, the filler is a precipitated calcium carbonate such as CalciRC 100 manufactured by Calci-Tech (Switzerland).

In another embodiment, the ink formulation of the invention comprises said mineral filler in an amount ranging from about 1 to 60%, more preferably about 1 to 40% and most preferably about 1 to 30% of the total weight of the formulation.

In order to provide a stable dispersion of said mineral filler in the formulation, the formulation may further comprise at least one dispersing agent which provides substantially a hard-cake free ink. The dispersing agent assist the dispersion of the mineral filler and other particulate components (such as pigments) in the formulation, prevent formation of hard cake during storage and further assists in adjusting the ink's surface tension. The ink may further comprise at least one wetting agent (a surfactant) which promotes wetting of the substrate on which the formulation is to be applied.

In one embodiment of the invention, said at least one wetting agent is selected from non-ionic surfactants, anionic surfactants and cationic surfactants.

In one preferred embodiment, said wetting agent is selected from fluoro-surfactants such as ZONYL manufactured by Du-Pont; silicone-surfactants, such as BYK 333 polyether modified poly dimethyl siloxane manufactured by BYK-CHEMIE and polyacrylate-surfactants such as BYK 353 manufactured by BYK-CHEMIE.

In another embodiment of the invention, the formulation comprises at least one dispersing agent (a dispersant) selected from (a) low molecular weight dispersants such as Disperbyk 110 and 111 acidic copolymers manufactured by BYK-CHEMIE, which are capable of penetrating into agglomerates of e.g., pigments and fillers and thus lower the attraction forces between particles, and (b) high molecular weight dispersants such as Disperbyk 161 and 163 copolymers manufactured by BYK-CHEMIE, which prevent re-agglomeration of said filler and pigment particulates.

In a preferred embodiment, the formulation comprises (a) 1 to 50% of at least one low molecular weight dispersing agent, and (b) 1 to 200% of at least one high molecular weight dispersing agent, said percentages being of the total weight of all fillers and pigments or dyes comprised in the formulation

The polyol provides at least one hydroxyl group which is reactive towards said phenolic resin and with said amino resin, if present in formulation, during the thermal curing stage. Preferably said polyol is reactive towards said phenolic resin at temperatures of about 120 to 220° C., but latent at ambient. More preferably, said polyol is further substituted by at least one unsaturated group, so as to increase reactivity towards said USM as well. Most preferably, said hydroxyl group is primary or secondary.

In one embodiment, the polyol is selected, in a non limiting manner, from acrylate and methacrylate esters of polyhydric alcohols, wherein not all of the hydroxyl groups are reacted. One example of such an acrylate ester is pentaerythritol triacrylate, known also as SR444 manufactured by Sartomer.

In another embodiment, said polyol is selected from allyl pentaerythritols, such as triallyl pentaerythritol sold as APE by Perstrop; and allyl ethers of trimethylol propane, pentaerythritol and glycerol, sold under the names Neoallyl T-20, P-30 and E-10, respectively, by DAISO Co. LTD, Japan.

In yet another embodiment, the polyol is selected from cycloaliphatic polyols such as cyclohexane dimethanol (for example the diol Unoxol manufactured by DOW).

In still another embodiment, the polyol is selected from styrene-allyl alcohol copolymers manufactured by Lyondell Corporation under the brand name SAA.

The formulation according the present invention comprises said polyol at about 1 to 50% of the total weight of the formulation. More preferably, the polyol constitutes about 1 to 30% and most preferably 1 to 20% of the total weight of the formulation.

In order to cure to tack-free state or enable significant increase in viscosity as the primary curing step, the printed ink is exposed to UV radiation or visible light emitted from suitable sources of actinic radiation. Such sources may be halogen light, mercury lamps, xenon lamps, carbon arc lamps, tungsten filament lamps, lasers, electron beam or sunlight. The light is applied on the printed ink within at most 60 minutes after ink jetting, more preferably within at most 60 seconds and most preferably within at most 10 seconds after ink-jetting.

The photoinitiator used for the curing process is selected from free radical generating photoinitiators, cationic photoinitiators and anionic photoinitiators, or any combination thereof.

In one embodiment, the photoinitiator is a free radical generator, which may be selected from anthraquinone and derivatives thereof, acetophenones, 1-hydroxy cyclohexyl-phenylketone and 2-methyl-1-(4 methylthio) phenyl-2-morpholin-propan-1-one; thioxanthones; ketals such as acetophenone dimethylketal and dibenzylketal; benzoins and benzoin alkyl ethers such as benzoin, benzyl benzoin methyl ether, benzoin isopropyl ether and benzoin isobutyl ether; azo compounds such as azobisisovaleronitrile; benzophenones such as benzophenone, methylbenzophenone, 4,4-dichlorobenzophenone, 4,4-bis-diethylamino benzophenone, Michler's ketone and xanthones, including mixtures thereof.

Preferably, the free radical generators are Speedcure™ ITX, EHA and 3040, Irgacure™ 184, 369, 907 and 1850 and Darocure™ 1173.

In another preferred embodiment, the photoinitiator is cationic radical generator selected from triarylsulfonium (TAS) and diaryliodonium (DAI) salts, oxime sulfonate, triarylsulfonium and diazonium salts.

The ink according the present invention comprises at least one photoinitiator at about 1 to 20%, more preferably about 1 to 15% and most preferably 1- to 10% of the total weight of the formulation.

The ink formulation may comprise additionally an amino resin cross-linker in an amount ranging from 0.01 to 30% of the total weight of the formulation, for improved adhesion and flexibility. Such an amino resin may be selected, in a non limiting manner from melamine monomer or polymer, melamine-formaldehyde resins, benzoguanamine-formaldehyde resins, urea-formaldehyde resins, glycoluril formaldehyde resins, triazine based amino resin and combinations thereof.

In a preferred embodiment, said amino resin is selected from melamine resins manufactured by CYTEC such as Cymel 300, 301, 303, 325 350, 370, 380, 1116 and 1130; benzoguanamine resins such as Cymel R 1123 and 1125; glycoluril resins such as Cymel 1170, 1171, and 1172 and urea resins such as CYMEL U-14-160-BX, CYMEL UI-20-E, CYMEL 325, CYMEL 322, CYMEL 3749, CYMEL 3050, CYMEL 1301 melamine based resins, CYMEL U-14-160-BX, CYMEL UI-20-E urea based amino resins, CYMEL 5010 and benzoguanamine based amino resin and CYMEL 5011 based amino resins, manufactured by CYTEC.

The formulation may further comprise an agent, which is capable of accelerating the curing process between the phenolic resin and optionally the amino resin and the hydroxyl groups of the said polyol, at elevated temperature, and also which has adhesion promoting effect. This agent is preferably an oligomer or polymer, having an acid number greater than 50 mg KOH/gr, more preferably greater than 100 mg KOH/gr and most preferably greater than 120 mg KOH/gr. The acidic groups bonded to said at least one oligomer or polymer are preferably selected from carboxyl, organic anhydrides, phosphoric ester derivatives and combination thereof.

One group of preferred oligomers are the weakly acidic oligomers or polymers (herein designated AC-POL) preferably selected, in a non limiting manner, from (a) acrylic or methacrylic acid co-polymers with other unsaturated monomers such as styrene, (b) maleic acid or anhydride copolymer with other unsaturated monomers such as styrene (For example styrene-maleic anhydride copolymer) or graft polymers wherein grafted group selected from carboxylic acids or anhydrides thereof, (c) polymers comprising phosphoric group and esters thereof, such as the additive ADDITOL XL 180 manufactured by Solutia, and (d) unsaturated polycarboxylic resins characterized by dual functionality, such as Sarbox SB500E 50 manufactured by Sartomer.

The AC-POL agent is mostly effective at levels of 1 to 10% and more preferably at levels of 0.5 to 5% of the total weight of the formulation.

Traces of low molecular weight ions, such as strong acid catalysts, may have a negative effect on the dielectric properties of the formulation. Surprisingly, the AC-POL agent acts as a “catalyst” for the curing stage and becomes part of the cured network, via a reaction of said phenolic resin with a carboxyl group or via the unreacted hydroxyl groups in the chain.

The AC-POL also imparts to the cured print an improved adhesion to metals, glass and ceramic materials as well as the potential “developability” of cured film in alkaline medium (an important feature for rework purposes, when cured ink needs to be removed without harm to the PCB).

In order to avoid a certain degree of curing which occurs at the ambient (and thus ensure latency) and in order to initiate enough cross linking at the thermal curing stage above 120° C., volatile amine inhibitors such as N-methyldiethanolamine (MDEA) is added to the ink formulation. Inhibitors such as MDEA are introduced into the formulation at a level of between 0.01 to 1.5%, more preferably between 0.1 to 0.7% of the total weight of the formulation.

This amine inhibitor neutralizes free acidic species when the ink is stored or even in the ink jet reservoir and pipes. Only when temperature rises above about 100° C. and evaporation of the amine inhibitor is enabled, the blocking is removed and the curing reaction commences.

The formulations of the present invention are typically prepared as ready-to-use formulations but may also be used as concentrates or master batches which include only a certain selection of components in a carrier. Such concentrate or master batch may be added to or admixed with the remaining components of the formulation thereby affording the read-to-use formulation of the invention.

### Example 1

### Preparation of the Ink Formulation

In a typical process, the solder mask formulation of the invention was manufactured according to the following method:
1. providing a clear solution of said at least one phenolic resin in at least one solvent, having a solid content of about 20 to 80% w/w;
2. mixing said phenolic resin solution, at least one polyol, at least one USM, optionally at least one additional solvent, at least one photoinitiator and at least one filler into said clear solution of step (1);
3. dispersing the mixture of step (2) by means of high shear;
4. milling the dispersed mixture of step (3), using any mill, preferably a high surface mill such as bead mill, pearl mill, sand mill and attritor or high energy mill such as rotor-stator, until at least 90% of the mixture is able to pass through a 2- or less micron filter; and
5. adjusting the viscosity and surface tension of the filtered formulation by optionally adding additional solvents, thereby obtaining the desirable solder mask ink formulation.

Alternatively, the at least one wetting agent, and/or dispersing agent, amino resin, and/or pigment or dye and/or adhesion promoter, and/or AC-POL and/or inhibitor may be added in step (1) or optionally in step (5). Additionally, the at least one solid phenolic resin, polyol and solvent may be mixed at step (1) until a clear solution is obtained.

The milling of step 4 is typically achieved by horizontal mill, 0.2-1 mm Zirconia, Alumina, ceramic or glass beads, at 500-5,000 RPM, with a residence time of about 0.5 to 5 minutes, at an ink temperature of about 15 to 25° C.

The surface tension of the formulation was typically measured using the Nouy ring method (KRUSS Company).

The viscosity at different shear rates was determined by the cone and plate Rheometer Model Rheo-Stress 1 manufactured by HHAKE.

### Example 2

### Printing of Solder Mask Formulation on PCBs

The printing process disclosed herein presents a novel balance between the throughput of production (fast curing) and the reliability of the printed solder mask (low level of shrinkage).

The printing process was carried out according to the following sequence:

(i) Pre-loading Stage—the ink formulation, which was stored at a temperature range of 10 to about 30° C., was agitated for re-dispersion, and let stay for at least 60 minutes with no agitation for removal of air bubbles. The newly dispersed solution was added into the ink-jet machine reservoir.

(ii) Printing Stage—the ink was pumped from the reservoir into the printing head via a filtering system, to further provide protection of the printing head from solid particles. The ink temperature was adjusted in the head to the jetting temperature, from ambient to about 100° C. and the ink was jetted according to a pre-defined pattern provided as a digital file to the printer (ink-jet printer such as Printar model LGP 809, equipped with un-doped medium pressure Hg UV lamp).

(iii) Partial Curing Stage—in order to obtain a tack-free or no-flow print, the printed PCB was irradiated with a UV and/or a visible light source, at most 10 seconds after drop landing on substrate. This light source may be mounted as an integral part of the print head construction, as a separate static device or as a mobile independent device. The light intensity was maintained in the range of about 50 to 5,000 mW/cm² and at a wavelength range of about 300 to 450 nm.

In order to provide highest reliability of the cured film, the tack-free film was re-exposed to a high power UV source (referred to as UV bump) having a light intensity of at least 200 mW/cm² in the range 300 to 450 nm, more preferably of about at least 1,000 mW/cm² and most preferably about at least 2,000 mW/cm². The accumulated light intensity over a typical printed area was maintained in the range of about 50 mJ/cm² to 5,000 mJ/cm². Preferably, the UV bump is provided by a secondary source, offline to the ink jet machine, in order to enable fast production rate.

For two-faced substrates, steps (ii) and (iii) were repeated for the second face.

(iv) Curing Stage—complete curing of said printed PCB was achieved by heating to temperature of about 120 to 220° C. preferably, the curing was achieved by heating in a convection oven or by exposure to IR radiation using an IR emitter.

### Example 3

### A First Solder Mask Formulation

This formulation of the invention was prepared according to the process of Example 1 above. The formulation comprised the following
(a) at least one USM such as SR 506 by Sartomer at a loading of 5 to 40% and/or SR 238 by Sartomer at a loading of 5 to 30%, of the total weight of the formulation;
(b) at least one unsaturated polyol such as SR 444 by Sartomer at a loading of 5 to 20%, of the total weight of the formulation;
(c) at least one photoinitiator such as Irgacure 907 by Ciba at a loading of 2 to 10%, of the total weight of the formulation;
(d) a phenolic cross linker solution comprising about 60% etherified phenolic resin and about 40% butanol and commercially available under the name FB 210 B60 by Schenectady, said phenolic resin provided at a loading of 5 to 40%, of the total weight of the formulation;
(e) an AC-POL solution SB500E50 by Sartomer at a loading of 1 to 10%, of the total weight of the formulation;
(f) at least one mineral filler such as barium sulfate Blank Fixe micro manufactured by Sachtleben, at a loading of 10 to 40%, of the total weight of the formulation; and additionally
(g) at least one wetting agent, and at least one dispersing agent, and at least one organic pigment and at least one rheology modifier and at least one curing inhibitor.

Physical Characteristics—The formulation was determined to have a viscosity of 10-12 cps at 40-45° C. at shear rate of 10 to 100,000 seq⁻¹ and surface tension of 28-34 dynes/cm. It additionally exhibited very high latency, namely its viscosity increased by at most 4 Cps when measured at 45° C., at a shear rate of 2,000 to 5,000 sec⁻¹, after being stored at 20-25° C. for 3 months.

Application and Curing—This formulation was applied by an ink jet printer such as Printar model LGP 809, equipped with un-doped medium pressure Hg UV lamp, onto a printed circuit board outer layer (FR4 laminate, with 35 microns copper pattern on outer layer, the copper being pumice treated).

At the first stage, upon printing, the print was irradiated by UV and visible radiation emitted from said UV lamp, at power of 100 to 1,000 mW/cm² in order to “freeze” the ink drops before propagation thereof on the substrate begun and in order to cross-link the printed ink to a tack-free state. This sequence of printing followed by immediate cross-linking by light is extremely important when the ink is applied onto the printed circuit board as solder mask, where high accuracy and resolution is crucial for accurately defining the pads to be soldered.

The tack-free print of printed film was then exposed to UV bump on a conveyor equipped with medium pressure Hg UV lamp to a total accumulated UV energy output of 500-2,000 mJ/cm² and then thermally cured at 15° C. for 60 minutes.

Physical Characteristics of Cured print—The cured film had outstanding chemical and thermal resistance, as well as adhesion to the copper and the laminate of the PCB. The cured film was qualified as solder mask according to procedures listed in IPC SM-840 C (class H and class T), a protocol written and revised by the Association of interconnecting and packaging electronic circuits.

The cured solder mask exhibited a dielectric strength of 4,000 to 5,000 V/mil, a value about 10 times greater than the minimal requirement by IPC-SM-840C. The ink also exhibited a resistance to electromigration, measured according to Bellcore GR-78-CORE, Issue 1, Section 13.2.7, of at least 3×10¹⁰ Ohms. This high resistance exhibited by the cured solder mask is rarely achieved by acrylate based solder masks, due to high degree of residual mobile ions, insufficient cross-link density and medium-to-poor adhesion to the copper substrate. The resistance against attack by ENIG was excellent, both on pumice treated copper and micro-etched copper.

### Example 4

### A Second Solder Mask Formulation

This formulation, manufactured according to the process of Example 1 above, comprised:
(a) at least one USM such as SR 506 by Sartomer, at a loading of 5 to 40%, and/or SR 238 by Sartomer, at a loading of 5 to 30% and/or triallyl isocyanurate, at loading of 1 to 20% of the total weight of the formulation;
(b) at least one unsaturated polyol such as SR 444 by Sartomer, at a loading of 5 to 15% of the total weight of the formulation;
(c) at least one photoinitiator such as Irgacure 907 by Ciba, at a loading of 2 to 10% of the total weight of the formulation;
(d) at least one sensitizer such as thioxanthone, at a loading of 0.2 to 2% of the total weight of the formulation;
(e) a phenolic cross linker solution comprising 60% vinyl phenol such as Maruka Lyncur CHM manufactured by Maruzen in butanol at a loading of 15 to 35% of the total weight of the formulation;
(f) an AC-POL solution such as SB500E50 by Sartomer, at a loading of 1 to 10% of the total weight of the formulation;
(g) a mineral filler such as barium sulfate Blank Fixe micro manufactured by Sachtleben, at a loading of 10 to 50% of the total weight of the formulation; and
(h) at least one wetting agent, and at least one dispersing agent, and at least one organic pigment and at least one rheology modifier and at least one curing inhibitor.

Physical Characteristics—The formulation was determined to have a viscosity of 9-12 cps at 40-45° C. at shear rate of 10 to 100,000 sec⁻¹ and surface tension of 28-34 dynes/cm. It additionally exhibited very high latency, namely its viscosity increased by at most 3 Cps, when measured at 45° C., at a shear rate of 2,000 to 5,000 sec⁻¹, after being stored at 20-25° C. for 3 months.

Application and Curing—

This formulation was applied by an ink jet printer such as Printar model LGP 809, equipped with un-doped medium pressure Hg UV lamp, onto a printed circuit board outer layer (FR4 laminate, with 35 microns copper pattern on outer layer, the copper being pumice treated).

At the first stage, upon printing, the print was irradiated by UV and visible radiation emitted from said UV lamp, at power of 100 to 1000 mW/cm² in order to “freeze” the ink drops before propagation thereof on the substrate begun and in order to cross-link the printed ink to a tack-free state. This sequence of printing followed by immediate cross-linking by light is extremely important when the ink is applied onto the printed circuit board as solder mask, where high accuracy and resolution is crucial for accurately defining the pads to be soldered.

The tack-free print of printed film was then exposed to UV bump on a conveyor equipped with medium pressure Hg UV lamp to a total accumulated UV energy output of 5004000 mJ/cm² and then thermally cured at 150° C. for 60 minutes.

Physical Characteristics of Cured Print—The cured film had outstanding chemical and thermal resistance, as well as adhesion to the copper and the laminate of the PCB. The cured film was qualified as solder mask according to procedures listed in IPC-SM-840 C (Class H and Class T), a protocol written and revised by the Institute for Interconnecting and Packaging Electronic Circuits.

The cured solder mask exhibited a dielectric strength of 4,000 to 5,000 V/mil, a value about 10 times greater than the minimal requirement by IPC-SM-840C. The ink also exhibited a resistance to electromigration, measured according to Bellcore GR-78-CORE, Issue 1, Section 13.2.7, of at least 4×10¹⁰ Ohms. This high resistance exhibited by the cured solder mask is rarely achieved by acrylate based solder masks, due to high degree of residual mobile ions, insufficient cross-link density and medium-to-poor adhesion to the copper substrate. The resistance against attack by ENIG was excellent, both on pumice treated copper and micro-etched copper.

### Example 5

### A Third Solder Mask Formulation

This formulation, manufactured according to the process of Example 1 above, utilized a cationic photoinitiator which releases strong acid in response to exposure to light. The formulation comprised:
(a) at least one USM such as SR 506 by Sartomer, at a loading of 5 to 40%, and/or SR 238 by Sartomer, at a loading of 5 to 30% of the total weight of the formulation;
(b) allyl pentaerythritol (APE) polyol manufactured by Perstrop, at a loading of 5 to 35%, of the total weight of the formulation;
(c) a cycloaliphatic epoxy such as Cyracure UVR-6105 manufactured by DOW, at a loading of 1 to 30% of the total weight of the formulation;
(d) a photoinitiator such as Irgacure 907 by Ciba, at a loading of 2 to 10% of the total weight of the formulation;
(e) a cationic photoinitiator such as Irgacure 250 by Ciba, at a loading of 2 to 10% of the total weight of the formulation;
(f) a phenolic cross linker solution comprising 60% etherified phenolic resin and 40% butanol, commercially available under the name FB 210 B60 by Schenectady, said phenolic resin provided at a loading of 5 to 40% of the total weight of the formulation;
(g) AC-POL solution such as SB500E50 by Sartomer, at a loading of 1 to 10% of the total weight of the formulation;
(h) a mineral filler such as barium sulfate, Blank Fixe manufactured by Sachtleben, at a loading of 10 to 60% of the total weight of the formulation; and
(i) at least one wetting agent, and at least one dispersing agent, and at least one organic pigment and at least one rheology modifier and at least one curing inhibitor.

Physical Characteristics—The formulation was determined to have a viscosity of 10-12 cps at 40-45° C. at shear rate of 10 to 100,000 sec⁻¹ and surface tension of 28-34 dynes/cm. It additionally exhibited very high latency, namely its viscosity increased by at most 3 Cps, when measured at 45° C., at a shear rate of 2,000 to 5,000 sec⁻¹, after stored at 20-25° C. for 3 months.

Application and Curing—This formulation was also applied by an ink jet printer such as Printar model LGP 809, equipped with un-doped medium pressure Hg UV lamp, onto a printed circuit board outer layer (FR4 laminate, with 35 microns copper pattern on outer layer, the copper being pumice treated).

At the first stage, upon printing, the print was irradiated by UV and visible radiation emitted from said UV lamp, at power of 100 to 1000 mW/cm² in order to “freeze” the ink drops before propagation thereof on the substrate begun and in order to cross-link the printed ink to a tack-free state. This sequence of printing followed by immediate cross-linking by light is extremely important when the ink is applied onto the printed circuit board as solder mask, where high accuracy and resolution is crucial for accurately defining the pads to be soldered.

The tack-free print of printed film was then exposed to UV bump on a conveyor equipped with medium pressure Hg UV lamp to a total accumulated UV energy output of 5004000 mJ/cm² and then thermally cured at 160° C. for 60 minutes.

Physical Characteristics of Cured print—The cured print or film had outstanding chemical and thermal resistance, as well as adhesion to the copper and the laminate of the PCB. The cured film was qualified as solder mask according to procedures listed in IPC SM-840 C (class H and class T), a protocol written and revised by the Association of interconnecting and packaging electronic circuits.

The cured solder mask exhibited a dielectric strength of 2,000 to 3,000 V/mil, a value about 6 times greater than the minimal requirement by IPC SM-840C. The ink also exhibited resistance to electromigration, measured according to Bellcore GR-78-CORE, Issue 1, Section 13.2.7, of at least 3×10¹⁰ Ohms. The resistance against attack by ENIG was excellent, both on pumice treated copper and micro-etched copper.

### Example 6

### A Fourth Solder Mask Formulation

The components of the ink formulation of this Example are listed in Table 1. These formulations were prepared according to procedure provided in Example 1.

TABLE 1
Further formulations of the present invention

| Component | Manufacturer | CAS | Role in Formula | % weight in formula |
|---|---|---|---|---|
| SR 444 | Sartomer | 4986-89-4 | polyol | 2-20 |
| | | 3524-69-3 | | |
| SR 238 | Sartomer | 13048-33-4 | USM | 5-30 |
| SR 506D | Sartomer | 5888-33-5 | USM | 10-40 |
| FB 210 B 60 | Schenectady | | Phenolic resin solution | 3-25 |
| | | | (60% solution of phenolic | (1.8 to 15% phenolic resin |
| | | | resin in butanol) | and 1.2-10% butanol) |
| Cymel 325 | Cytec | 68002-20-0 | Co-cross linker | 5-15 |
| | | 78-83-1 | 80% solution of melamine | (4 to 12 amino resin |
| | | | formaldehyde amino resin | and 1 to 3 isobutanol |
| | | | in isobutanol | |
| Sarbox500E50 | Sartomer | | AC-POL | 1-10 |
| BaSO4 Blank | Sachtleben | 7727-43-7 | Filler | 10-40 |
| Fixe micro | | | | |
| Aerosil | Degussa | | Rheology modifier | 0.2-2 |
| Disperbyk 111 | BYK | 108-65-6 | Dispersing agent | 0.1-5 |
| | | 64742-95-6 | | |
| | | 7664-38-2 | | |
| Disperbyk 168 | BYK | 108-65-6 | Dispersing agent | 0.1-5 |
| | | 123-86-4 | | |
| Disperbyk 163 | BYK | 1330-20-7 | Dispersing agent | 0.1-5 |
| | | 108-65-6 | | |
| | | 123-86-4 | | |
| Hostaperm | Clariant | 1328-53-6 | Pigment | 0.1-5 |
| Green GG 01 | | | | |
| BYK 358 | BYK | 64742-95-6 | Wetting agent | 0.1-2 |
| Irgacure 907 | Ciba | 71868-10-5 | Photoinitiator | 1-15 |
| Dowanol PMA | DOW | 108-65-6 | Solvent | 0-10 |
| MDEA | | 105-59-9 | Curing inhibitor, | 0.2-2 |
| | | | acid blocker | |

The surface tension of the ink formulation according to Table 1 were measured at 45° C. to be 28-33 dynes/cm. The viscosity was measured at between 10 and 13 cps at 45° C. at a shear rate of 2,000-5,000 sec⁻¹ (measured at the same temperature). The ink formulations exhibited very high latency, with a viscosity increase of at most 3 Cps, when measured at 45° C. at 2,000-5,000 sec⁻¹, after being stored at 20-25° C. for 3 months.

Application of the ink onto PCBs was performed identically to the exemplified in Examples 3 to 5.

The cured films prepared from these formulations had outstanding chemical and thermal resistance, as well as adhesion to the copper and the laminate of the PCB, as is discussed hereinbelow in Examples 7 and 8. The cured film was qualified as solder mask according to procedures listed in IPC-SM-840 C (Class H and Class T), a protocol written and revised by the Institution for Interconnecting and Packaging Electronic Circuits.

### Example 7

### Evaluation of a Solder Mask of Table 1 According to IPC-SM-840C, Amendment 1, Column A, Classes T and H

Fourteen ink-jet solder mask coated specimens, manufactured according to the method of the present invention and employed a formulation according to Table 1, were tested in accordance with IPC-SM-840C, Amendment 1, Column A, Classes T (telecommunications) and H (high reliability).

Visual—

The solder mask appearance was evaluated visually in all stages of evaluation, qualification and conformance inspection with the aid of a magnifying lens according to IPC-SM-840C, Amendment 1, paragraph 3.4.8.

There was no evidence of cracks, inclusions, peeling, or roughness. The solder masks were uniform in appearance and free of foreign materials.

Non-Nutrient—

The solder mask was evaluated for the contribution to, support or sensitivity towards biological growth when tested as specified in IPC TM 650, method 2.6.1E (see IPC-SM-840C, Amendment 1, paragraph 3.4.6).

The solder masks showed no growth of biological specimens.

Flammability—

The flammability of the solder mask specimens was evaluated in an open oxygen column according to IPC-SM-840C, Amendment 1, paragraph 3.6.3.2. The required value for the oxygen index (determined per ASTM D2863) was >28%.

The oxygen index for the tested solder mask specimens was 36%.

The specimens were additionally tested for flammability in accordance with IPC-SM-840C, Amendment 1, paragraph 3.6.3.1. The specimens did not raise the UL94 “V” number of the base laminate.

Hydrolytic stability/Aging—

The solder mask specimens were tested at 97° C., 90-98% relative humidity for a duration of 28 days. Resistance to reversion was determined by examining the appearance and surface thickness in accordance with TM 2.6.11C of IPC TM 650.

There was no evidence of reversion. There was no evidence of cotton particles adhering to the solder mask surface.

Dielectric Streneth—

The thickness of the solder mask specimens was tested. The solder mask material was required to meet or exceed the minimum value of 500 VDC per 0.025 mm of thickness.

The solder mask specimens showed a dielectric strength ranging from 571 to 750 V/mil.

### Example 8

### Evaluation of a Solder Mask of Table 1 According to IPC-SM-840C, Amendment 1, Column B. Classes T and H

Twenty four ink jet solder mask specimens manufactured according to the present invention, employing a formulation according to Table 1, on FR-4 laminate with copper patterns, were tested in accordance with IPC-SM-840C, Amendment 1, Column B, classes T (telecommunication) and H (high reliability).

Machinability—

The solder mask applied over the base laminate was evaluated for cracks or torn in comparison to that observed on the substrate used when subjected to drilling, routing, sawing or punching that is normally associated with the printed board manufacturing process.

The solder mask specimens were not cracked or torn more than that observed on the substrate.

Cure—

The resistance, solderability and solder resistance of the solder mask specimens towards solvents and cleaning agents were tested.

The specimens met the requirements of solvent and cleaning agent resistance, solderability and solder resistance. The specimens were properly cured.

Pencil Hardness—

The solder mask specimens were tested in accordance with IPC TM 650 for hardness to scratching by a pencil which is softer than an “F” hardness.

The pencil hardness that did not cut or gouge the specimens before or after solder exposure was 6H.

Adhesion—

The adhesion of the cured specimens to melting (such as tin-lead or bright acid tin when exposed above its melting point) or to non-melting (such as copper, nickel, etc) metals was determined according to IPC TM 650, method 2.4.281D.

There was no solder mask removed from the laminate or conductive surfaces before or after solder exposure.

Resistance to Solvents and Cleaning Agents—

Resistance to solvents and cleaning agents such as isopropanol, limonene, alkaline solutions and water in accordance with IPC-SM-840C, amendment 1, paragraph 3.6.1.1 was evaluated.

The solder mask specimens did not exhibit any roughness, blisters, delamination, cracking, swelling and color change after exposure to the solvents or cleaning agents listed in the specific IPC section.

Solderability—

The solderability was tested in accordance with ANSI/J-STD-003.

The solder mask coating of the specimens did not adversely affect the solderability of the areas which were intended to be soldered.

Resistance to Solder—

Immediately after exposure to solder, the specimens were visually inspected in accordance with paragraph 3.4.8 IPC for resistance to accept solder. The required result was the complete resistance to adherence of solder.

There was no solder adhering to the surface of the solder mask specimens.

Insulation Resistance—

The specimens were tested for minimum insulation resistance, before and after performing the resistance to solder detailed above. The solder mask specimens should have a minimum insulation resistance of 500 (5.0×10⁸ ohms), with a minimum spacing greater than or equal to 0.125 mm.

The specimens exhibited insulation resistance of in the order to 1012 ohms.

Moisture and Insulation Resistance—The resistance to moisture and insulation was tested in accordance with IPC-SM-840C, amendment 1, paragraph 3.9.1. The solder mask should withstand the employed conditions without exhibiting blistering or separation.

The average insulation resistance measured was 5.95×103 megaohms. There was no evidence of blistering, delamination or other forms of degradation of the solder mask specimens.

Electrochemical Migration—

The specimens were tested according to IPC-SM-840C, Amendment 1, paragraph 3.9.2. The specimens should not exhibit evidence of electrochemical migration when tested as specified in accordance with IPC-TM-650, method 2.6.14C.

The average insulation resistance did not degrade by more than a decade as a result of an applied bias. The resistance measurements in megaohms were 1.48×10² (96 hours), 8.5×10¹ (500 hours), 1.0×10⁵ (before chamber conditioning) and 9.7×10² (after chamber conditioning).

Thermal Shock—

The solder mask specimens were tested in accordance with IPC-SM-840C paragraph 3.9.3 utilizing thermal shock conditions varying from −65° to +125° C.

There was no evidence for blistering, crazing, delamination, or cracking of the solder mask.

### Example 9

### Evaluations of the Solder Masks of Table 2

Table 2 lists additional ink-jet formulations prepared in accordance with the present invention. The resistance of the films prepared from these formulations was evaluated under various chemical and physical conditions as listed in Table 3.

Table 4 summarizes the stability of each of the solder masks prepared from the formulations of Table 2 in organic solvents, and under conditions typically employed in the PCB industry, such as soldering, immersion tin surface finish, electroless nickel/gold (ENIG). As may be noted, solder masks prepared from Formulations 1, 2, 4, 6, and 7 showed good to excellent stability under each of the conditions employed. While the solder mask prepared from Formulation 6 showed excellent stability, it nonetheless was too viscous and jetting was possible only at 60° C. instead 40° C. While the solder mask of Formulation 7 showed excellent stability, the absence of an inhibitor to the acidic catalyst required that the formulation be used within a short period of time after manufacture as the formulation exhibited shorter pot life.

TABLE 2
Formulations of the Invention. Each value represents % weight of the total weight of the formulation.

| Component | Manufacturer | Formula 1 | Formula 2 | Formula 3 | Formula 4 | Formula 5 | Formula 6 | Formula 7 | Formula 8 |
|---|---|---|---|---|---|---|---|---|---|
| SR 444 | Sartomer | 7 | 7 | 10 | 7 | 10 | 6 | 7 | 8 |
| SR 238 | Sartomer | 13.5 | 20 | 17.5 | 13.7 | 20 | 9 | 13.5 | 13 |
| SR 506D | Sartomer | 33.5 | 27 | 36.5 | 33 | 38.55 | 25 | 33.5 | 35 |
| FB 210 B 60 | Schenectady | 10 | 10 | 0 | 18 | 20 | 9.55 | 10 | 10 |
| Cymel 325 | Cytec | 7.7 | 7.7 | 7.7 | 0 | 0 | 5 | 7.7 | 7.65 |
| Sarbox500E50 | Sartomer | 1.95 | 1.95 | 1.95 | 1.95 | 3 | 2 | 1.95 | 0 |
| BaSO_{4 (Blank Fixe micro)} | Sachtleben | 17.9 | 17.9 | 17.9 | 17.9 | 0 | 35 | 18.65 | 17.9 |
| Aerosil R 972 | Degussa | 0.4 | 0.4 | 0.4 | 0.4 | 0.4 | 0.4 | 0.4 | 0.4 |
| Disperbyk 111 | BYK | 0.4 | 0.4 | 0.4 | 0.4 | 0.4 | 0.4 | 0.4 | 0.4 |
| Disberbyk 168 | BYK | 2.9 | 2.9 | 2.9 | 2.9 | 2.9 | 2.9 | 2.9 | 2.9 |
| Disperbyk 163 | BYK | 0.1 | 0.1 | 0.1 | 0.1 | 0.1 | 0.1 | 0.1 | 0.1 |
| Hostaperm Green | Clariant | 0.4 | 0.4 | 0.4 | 0.4 | 0.4 | 0.4 | 0.4 | 0.4 |
| GG 01 | | | | | | | | | |
| Irgacure 907 | Ciba | 3.5 | 3.5 | 3.5 | 3.5 | 3.5 | 3.5 | 3.5 | 3.5 |
| MDEA | | 0.75 | 0.75 | 0.75 | 0.75 | 0.75 | 0.75 | 0 | 0.75 |

TABLE 3
An overview of the different chemicals to which the solder mask was exposed to

| | | Exposure time and | |
|---|---|---|---|
| Procedure Description | Chemical medium | Temperature | Pass criteria |
| Resistance to organic solvent | Dichloromethane (DCM) | 50 rubbings, cotton cloth, | No printed material was Attacked |
| | | ambient | (visual) or lost Adhesion (tape test) |
| Resistance to soldering | Flux AF 1863, | 5 times 10 seconds @ 260 | No printed material was Attacked |
| | manufactured by Enthone, | Celsius | (visual) or lost Adhesion (tape test) |
| | solder Pb37Sn63 | | |
| Resistance to immersion Tin | Immersion Tin by Atotech | According to | No printed material was Attacked |
| surface finish | | manufacturer | (visual) or lost Adhesion (tape test) |
| | | recommendations | |
| Resistance to electroless | ENIG by Atotech | According to | No printed material was Attacked |
| Nickel/gold (ENIG) surface | | manufacturer | (visual) or lost Adhesion (tape test) |
| finish | | recommendations | |

TABLE 4
chemical resistance of the ink formulations listed in Table 2

| Formula | Resistance to | Resistance to | Resistance to immersion | Resistance to electroless |
|---|---|---|---|---|
| Name | Organic solvent | soldering | Tin surface finish | Nickel/gold (ENIG) |
| 1 | Excellent | Excellent | Excellent | Excellent |
| 2 | Excellent | Excellent | Excellent | Excellent |
| 3 | Excellent | good | medium | medium-poor |
| 4 | Excellent | Excellent | Excellent | Excellent |
| 5 | Poor - lost adhesion | Poor - lost adhesion | Poor - lost adhesion | Poor - lost adhesion |
| 6 | Excellent | Excellent | Excellent | Excellent |
| 7 | Excellent | Excellent | Excellent | Excellent |
| 8 | Good | Good-medium | Medium | Medium |

1-85. (canceled)

86. An ink-jet ink formulation comprising: (a) at least one compound capable of self cross-linking (USM); (b) at least one phenolic resin; (c) at least one solvent; (d) at least one mineral filler; (e) at least one polyol; and (f) at least one photoinitiator.

87. The ink formulation according to claim 86, wherein the ink is latent.

88. The ink formulation according to claim 86, having a viscosity lower than 50 Cps at a shear rate of 10 to 100,000 sec⁻¹ as measured at a temperature lower than 100° C., and a surface tension lower than 40 dynes/cm measured at the same temperature.

89. The ink formulation according to claim 86, wherein said at least one USM having at least one characteristic selected from:
a glass transition temperature (Tg) of at least 80° C.;
a molecular weight lower than 5,000 Daltons; and/or
a viscosity lower than 500 Cps at a temperature lower than 100° C.

90. The ink formulation according to claim 86, wherein said at least one USM is an unsaturated monomer or oligomer capable of self-cross-linking via free radical mechanism, said unsaturated monomer or oligomer is selected from acryl, methacryl, vinyl, allyl ether, allyl ester, fumaryl or any combination thereof, said unsaturated group being covalently bonded to a backbone selected from polyhydric alcohol, isocyanuric acid and derivatives thereof, novolac resin, urethane containing oligomers, amide containing oligomers, epoxy resin and derivatives thereof, isobornyl and derivatives thereof, imide containing oligomer, cycloaliphatic ring system, heterocyclic ring system and derivatives thereof.

91. The ink formulation according to claim 90, wherein said USM is selected from isobornyl acrylate or methacrylate; acrylate or methacrylate esters of short polyols and polyhydric alcohols; urethane acrylate or methacrylate; acrylate or methacrylate esters of short diols; acrylate or methacrylate ester of alkoxylated polyols; acrylate or methacrylate ester of tris-2-hydroxyethyl isocyanurate (THEIC); acrylate or methacrylate esters of cycloaliphatic diols and polyols; high functionality polyacrylate or methacrylate; allyl ethers; allyl esters; triazine based acrylates or methacrylates; dendritic polyol acrylates or methacrylates; imide group containing acrylates or methacrylates; and the reaction product of acrylic acid or methacrylic acid with novolak epoxy resins or bisphenol based epoxy resins.

92. The ink formulation according to claim 86, wherein said at least one phenolic resin is selected from: (a) phenol aldehyde condensates and hydrogenated grades thereof; (b) homo-polymers and copolymers of alkenyl phenols and hydrogenated grades thereof; (c) poly(vinyl phenol) resins and co-polymers and hydrogenated grades thereof; (d) oligomers and polymers comprising phenolic units and non-aromatic cylicalcohol units and hydrogenated grades thereof; and (e) homo-polymers and co-polymers of N-hydroxyphenyl-maleimides.

93. The ink formulation according to claim 92, wherein said phenolic resin is poly(vinyl phenol), (vinyl phenol) co-polymer, and hydrogenated grades thereof or an etherified phenolic resin.

94. The ink formulation according to claim 93, wherein said phenolic resin is a solid resin or a solution thereof pre-dissolved in an organic solvent.

95. The ink formulation according to claim 94, wherein said organic solvent is selected from ethers, alcohols, glycols, lactones, esters, cyclic amides, cyclic esters, ether-esters, alkyl carbonates, ketones, aromatic, aliphatic, amide, cycloaliphatic, silyl solvents, and combinations thereof.

96. The ink formulation according to claim 95, wherein said solvent is a volatile hydroxylated solvent selected from ethanol, propanol, butanol and iso-butanol.

97. The ink formulation according to claim 86, wherein said at least one solvent has a viscosity in the range 1 to 15 Cps at ambient.

98. The ink formulation according to claim 97, wherein said at least one solvent is selected from ethers, alcohols, glycols, lactones, esters, cyclic amides, cyclic esters, ether-esters, alkyl carbonates, ketones, aromatic, aliphatic, amide, cycloaliphatic, silyl solvents, and combinations thereof.

99. The ink formulation according to claim 105, wherein said solvent is a volatile hydroxylated solvent selected from ethanol, propanol, butanol or iso-butanol.

100. The ink formulation according to claim 86, wherein said mineral filler is composed of particulates each having a surface area lower than 100 m²/gr.

101. The ink formulation according to claim 100, wherein said particulate is characterized by an average particle size of less then 5 microns.

102. The ink formulation according to claim 101, wherein said particle size is of less than 2 microns.

103. The ink formulation according to claim 102, wherein said at least one mineral filler has a refractive index in the range of about 1.4 to 1.7.

104. The ink formulation according to claim 103, wherein said mineral filler is selected from metal oxides, metal carbonates, metal sulfates, metal phosphates, alumosilicates, kaolin, talc, wollastonite, mica, silica and silicates.

105. The ink formulation according to claim 104, wherein said metal carbonate is calcium carbonate, said metal sulfate is barium sulfate, and wherein said silicate is quartz.

106. The ink formulation according to claim 86, wherein said at least one polyol is substituted by ai least one reactive hydroxyl group.

107. The ink formulation according to claim 106, wherein said at least one hydroxyl group is reactive towards said phenolic resin at temperatures of about 120 to 220° C.

108. The ink formulation according to claim 106, wherein said polyol is selected from allyl ester, allyl ether, and acrylate or methacrylate esters of polyhydric alcohols.

109. The ink formulation according to claim 108, wherein said polyol is selected from allyl pentaerythritols and allyl ethers of trimethylol propane or pentaerythritol or glycerol.

110. The ink formulation according to claim 86, wherein said at least one photoinitiator is selected from free radical generating photoinitiators, cationic photoinitiators, and anionic photoinitiators or any combinations thereof.

111. The ink formulation according to claim 110, wherein said photoinitiator is a free-radical generator selected from anthraquinone and derivatives thereof; acetophenones; 1-hydroxy cyclohexyl-phenylketone and 2-methyl-1-(4 methylthio) phenyl-2-morpholin-propan-1-one; thioxanthones; ketals; benzoins and benzoin alkyl ethers; azo compounds; benzophenones; and mixtures thereof.

112. The ink formulation according to claim 110, wherein said photoinitiator is a cationic radical generator selected from triarylsulfonium (TAS) and diaryliodonium (DAI) salts, oxime sulfonate, and diazonium salts.

113. The ink formulation according to claim 111 further comprising at least one amino resin cross-linker being selected from melamine monomer or polymer, melamine-formaldehyde resins, benzoguanamine-formaldehyde resins, urea-formaldehyde resins, glycolurilformaldehyde resins, triazine based amino resin and any combinations thereof.

114. The ink formulation according to claim 112 further comprises at least one of the following: sensitizer, pigment, dye, wetting agent, dispersing agent, blocked strong acid catalyst, adhesion promoter, defoamer, curing inhibitor, or any combination thereof.

115. The ink formulation according to claim 114 wherein said at least one wetting agent is selected from fluoro-surfactants; silicone-surfactants, polyether modified poly dimethyl siloxane and polyacrylate-surfactants.

116. The ink formulation according to claim 114, wherein said at least one dispersing agent is selected from low molecular weight dispersants and high molecular weight dispersants.

117. The ink formulation according to claim 114, wherein said at least one pigment or dye has a color which remains substantially unchanged under conditions employed in the processes of PCB manufacturing.

118. The ink formulation according to claim 86, comprising (a) at least one USM in an amount between about 5 to 70%, of the total weight of the formulation; (b) at least one phenolic resin in an amount between about 1 to 50%, of the total weight of the formulation; (c) at least one solvent in an amount between 2 to 25%, of the total weight of the formulation; (d) at least one mineral filler in an amount ranging from about 1 to 70%, of the total weight of the formulation; (e) at least one polyol in an amount between 1 to 50%, of the total weight of the formulation; and (f) at least one photoinitiator in an amount between 1 to 20%, of the total weight of the formulation.

119. The ink formulation according to claim 118, comprising (a) at least one USM in an amount between about 5 to 60% of the total weight of the formulation; (b) at least one phenolic resin in an amount between about 1 to 30% of the total weight of the formulation; (c) at least one solvent in an amount between about 2 to 15% of the total weight of the formulation; (d) at least one mineral filler it an amount ranging from about 1 to 50% of the total weight of the formulation; (e) at least one polyol in an amount between about 1 to 30% of the total weight of the formulation; and (f) at least one photoinitiator in an amount between about 1 to 15% of the total weight of the formulation.

120. The ink formulation according to claim 119, comprising (a) at least one USM in an amount between about 5 to 50% of the total weight of the formulation; (b) at least one phenolic resin in an amount between about 1 to 30% of the total weight of the formulation; (c) at least one solvent in an amount between about 2 to 12% of the total weight of the formulation; (d) at least one mineral filler in an amount ranging from between about 1 to 40% of the total weight of the formulation; (e) at least one polyol in an amount between about 1 to 20% of the total weight of the formulation; and (f) at least one photoinitiator in an amount between about 1 to 10% of the total weight of the formulation.

121. The ink formulation according to claim claim 120, comprising between about 5 to 50% USM, 1 to 40% phenolic resin, 2 to 20% solvent, 0 to 20% amino resin, 5 to 60% mineral filler, 2 to 40% polyol, 1 to 15% photoinitiator, 0 to 5% pigment or dye and 0 to 10% wetting and/or dispersing agents, of the total weight of the formulation.

122. The ink formulation according to claim 121, wherein said polyol is substituted by at least one unsaturated group.

123. The ink formulation according to claim 122, comprising between about 5 to 50% USM, 1 to 40% phenolic resin, 2 to 20% solvent, 0 to 20% amino resin, 0 to 30% epoxy resin or monomer, 5 to 60% mineral filler, 2 to 40% polyol substituted by at least one unsaturated group, 1 to 15% free-radical photoinitiator, 1 to 10% cationic photoinitiator, 0 to 5% pigment or dye and 0 to 10% wetting and/or dispersing agents, of the total weight of the formulation.

124. The ink formulation according to claim 86 further comprising 1 to 10% blocked strong acid catalyst.

125. The ink formulation according to claim 114, wherein said at least one inhibitor is a volatile amine inhibitor.

126. The ink formulation according to claim 125, wherein said volatile amine inhibitor is N-methyldiethanolamine (MDEA).

127. The ink formulation according to claim 126, comprising: 2 to 15% polyol SR 444; 1 to 20% of a first USM SR 238; 1 to 40% of a second USM SR 506D; 5 to 50% phenolic resin solution FB210 B 60; 5 to 35% amino resin solution Cymel 325; 1 to 10% AC-POL Sarbox 500E50; 1 to 30% of a first mineral filler Barium sulfate; 0.1 to 30% of a second mineral filler Aerosil R972; 0.1 to 5% of a first dispersing agent DisperByk 111; 0 to 5% of a second dispersing agent DisperByk 168; 0 to 1% of a third dispersing agent DisperByk 163; 0.1 to 10% pigment Hostaperm Green GG01; 0 to 1% wetting agent Byk 358; 1 to 15% free radical generating photoinitiator Irgacure 907; 2 to 20% solvent; and 0.2 to 2% curing inhibitor MDEA.

128. The ink formulation according to claim 127, comprising: 6.99% polyol SR 444; 13.50% of a first USM SR 238; 33.22% of a second USM SR 506D; 10.07% phenolic resin solution FB210 B 60; 7.69% amino resin solution Cymel 325; 1.98% AC-POL Sarbox 500E50; 17.94% of a first mineral filler Barium sulfate; 0.39% of a second mineral filler Aerosil R972; 0.45% of a first dispersing agent DisperByk 111; 2.87% of a second dispersing agent DisperByk 168; 0.12% of a third dispersing agent DisperByk 163; 0.40% pigment Hostaperm Green GG01; 0.12% wetting agent Byk 358; 3.53% free radical generating photoinitiator Irgacure 907; and 0.73% curing inhibitor MDEA.

129. A method for the manufacture of an ink-jet ink formulation, said method comprising:
(i) providing a solution of a phenolic resin in at least one first solvent;
(ii) admixing at least one polyol, at least one USM, optionally at least one second solvent, at least one photoinitiator and at least one filler into said solution of step (i);
(iii) dispersing the mixture of step (ii) by means of high shear;
(iv) milling the dispersed mixture of step (iii) until at least 90% of the mixture weight is able to pass through a 2- or less micron filter; and
(v) adjusting the viscosity and surface tension of the filtered formulation of (iv) by adding a further amount of said first or said second solvent or at least one of a different solvent, thereby obtaining the desirable ink formulation.

130. The method for the manufacture of an ink-jet ink formulation, said method comprising:
(i) providing a solution of a phenolic resin in at least one first solvent;
(ii) admixing at least one polyol, at least one USM, optionally at least one second solvent, at least one photoinitiator and at least one filler into said solution of step (i);
(iii) dispersing the mixture of step (ii) by means of high shear;
(iv) milling the dispersed mixture of step (iii) until at least 90% of the mixture weight is able to pass through a 2- or less micron filter; and
(v) adjusting the viscosity and surface tension of the filtered formulation of (iv) by adding a further amount of said first or said second solvent or at least one of a different solvent, thereby obtaining the desirable ink formulation, for the preparation of the ink formulation of claim 86.

131. The method according to claim 129, wherein said first solvent, said second and said different solvent are identical.

132. The method according to claim 129, wherein said first solvent is different from said second solvent.

133. The method according to claim 129, wherein at least one wetting agent, dispersing agent, adhesion promoter, curing inhibitor or any combination thereof is added in step (i).

134. The method according to claim 129, wherein said at least one USM, photoinitiator and optionally sensitizer, or any combination thereof is added in step (v).

135. A solder mask formulation for PCB being adapted for ink jet printing, characterized by having a viscosity lower than 50 Cps at a shear rate of 10 to 100,000 sec⁻¹ measured at a temperature lower than 100° C., and a surface tension lower than 40 dynes/cm at the same temperature.

136. A method for ink-jetting a solder mask ink formulation onto a substrate, said method comprising:
(i) providing an ink formulation according to claim 128;
(ii) applying said ink formulation onto a first face of a substrate;
(iii) irradiating said substrate of (ii) by UV radiation and/or visible light, to afford a partially cured tack-free solid print;
(iv) optionally repeating steps (ii) and (iii) on a second face of said substrate;
(v) optionally irradiating said first face and/or said second face of said substrate by a high power UV and/or visible light source; and
(vi) curing said first face and/or said second face of said printed substrate at a temperature of about 120 to 220° C.

137. The method according to claim 136, wherein said high power UV and/or visible light source employed in step (v) has an intensity of at least 200 mW/cm² in the range 300-450 nm.

138. The method according to claim 136, wherein said print is a mark, a character or a film.

139. The method according to claim 138, wherein said print is a solder mask.

140. The method according to claim 138, wherein said substrate is a metal or metal oxide surface, glass, ceramic, plastic composite or PCB.

141. The method according to claim 140, wherein said substrate is PCB.

142. The method according to claim 141, wherein said PCB is a single or multi layered PCB.

143. The method according to claim 141, wherein said PCB is the outer layer thereof.

144. A solder mask prepared according to claim 143.

145. A solder mask prepared from the formulation of claim 128.

146. A solder mask prepared from a formulation manufactured according to the method of claim 129.

147. The solder mask according to claim 144 being characterized by a dielectric strength of between 200 and 5,000 V/mil.

148. The solder mask according to claim 146 being characterized by a resistance to electromigration, measured at least 5×10¹² Ohms.

149. The solder mask according to claim 148 having the characteristics required by the IPC SM-840 C standard.

150. A solder mask complying with the requirements of the IPC-SM-840-C prepared from the formulation of claim 128.

151. A solder mask complying with the requirements of the IPC-SM-840-C prepared according to the method of claim 143.
